(19) United States
(12) Patent Application Publication
(10) Pub. No.: US 2016/0124752 A1
(43) Pub. Date: May 5, 2016

(54) ELECTRONIC APPARATUS AND TEMPERATURE CONTROL METHOD THEREOF

(71) Applicant: Wistron Corporation, New Taipei City (TW)

(72) Inventor: Kuan-Ting Kuo, New Taipei City (TW)

(21) Appl. No.: 14/833,142

(22) Filed: Aug. 23, 2015

(30) Foreign Application Priority Data
Nov. 3, 2014 (TW) 103138053

(51) Int. Cl. G06F 9/44

(52) U.S. Cl. CPC G06F 9/4406

(57) ABSTRACT

An electronic apparatus and a temperature control method are provided. The steps of the temperature control method include: setting a preset temperature information, wherein the preset temperature information comprises a plurality of application program names and a plurality of respectively corresponding heat dissipation setting information about a heat dissipation ability of a heat dissipation apparatus; checking whether a name of an executed application program is one of the application program names or not, and selecting one of the heat dissipation setting information corresponding to the executed application program to be a selected heat dissipation information; and, driving the heat dissipation apparatus according to the selected heat dissipation setting information.

### CROSS-REFERENCE TO RELATED APPLICATION

This application claims the priority benefit of Taiwan application serial no. 10338053, filed on Nov. 3, 2014. The entirety of the above-mentioned patent application is hereby incorporated by reference herein and made a part of this specification.

### BACKGROUND OF THE INVENTION

1. Field of the Invention

The invention relates to a temperature control method of an electronic apparatus, and particularly relates to a temperature control method according to an application program that is executed.

2. Description of Related Art

Regarding heating dissipation of electronic apparatuses (e.g. a laptop computer), the operation of the heat dissipation fan thereof in the conventional technology is determined by a temperature control table. In addition, the temperature control table in the conventional technology is provided to an embedded controller to control the fan speed of the heat dissipation fan based on the increase or decrease of a current working temperature. However, as the fan speed of the heat dissipation fan becomes higher, the noise made accordingly also becomes louder.

Under such circumstance, the noise made by the heat dissipation fan of the electronic apparatus may be unbearable for the user when the user is in a scenario with a relatively higher quietness requirement. In this way, the work of the user may be influenced or interrupted.

In addition, to adjust the fan speed of the heat dissipation fan of a conventional laptop, the setting of basic input output system (BIOS) or an embedded controller of the laptop computer needs to be adjusted. The adjustment may be achieved by adjusting the firmware. However, loading new firmware adds the cost of time and human resource for testing, making it not the most convenient way.

### SUMMARY OF THE INVENTION

The invention provides an electronic apparatus and a temperature control method thereof capable of adjusting a working state of a heat dissipation apparatus according to an application being executed by the electronic apparatus.

A temperature control method according to the invention is suitable for an electronic apparatus, and includes steps as follows: setting a preset temperature information, wherein the preset temperature information comprises a plurality of application program names and a plurality of respectively corresponding heat dissipation setting information about a heat dissipation ability of a heat dissipation apparatus; checking whether a name of an executed application program is one of the application program names or not, and finding a selected heat dissipation setting information corresponding to the executed application program according to the preset temperature information; and driving the heat dissipation apparatus according to the selected heat dissipation setting information.

According to an embodiment of the invention, the step of finding the selected heat dissipation setting information corresponding to the executed application program according to the preset temperature checking information includes: executing a monitoring program to find the selected heat dissipation setting information corresponding to the executed application program in the preset temperature information; and providing the selected heat dissipation setting information to a basic input output system through the monitoring program.

According to an embodiment of the invention, the step of driving the heat dissipation apparatus according to the heat dissipation setting information includes: providing the basic input output system to write the selected heat dissipation setting information to a memory; and providing an embedded controller to set a heat dissipation ability of the heat dissipation apparatus according to the selected heat dissipation setting information in the memory.

According to an embodiment of the invention, the heat dissipation apparatus is a heat dissipation fan, and the selected heat dissipation setting information is configured to set a fan speed of the heat dissipation fan.

According to an embodiment of the invention, the steps of the temperature control method further include: providing a user interface to allow a user to edit the preset temperature information.

An electronic apparatus according to the invention includes a storage apparatus, a processor, a basic input output system, an embedded controller, and a heat dissipation apparatus. The storage apparatus is configured to store a preset temperature information, wherein the preset temperature information includes a plurality of heat dissipation setting information respectively corresponding to a plurality of application programs. The processor is coupled to the storage apparatus, reads the preset temperature information, and checks whether a name of an executed application program is one of the application programs to find a selected heat dissipation setting information corresponding to the executed application program in the preset temperature information. The basic input output system is coupled to the processor to receive the selected heat dissipation setting information. The embedded controller is coupled to the basic input output system. The heat dissipation apparatus is coupled to the embedded controller. In addition, the basic input output system writes the selected heat dissipation setting information to the embedded controller, and the embedded controller drives the heat dissipation apparatus according to the selected heat dissipation setting information.

Based on the above, the electronic apparatus of the invention is provided with the preset temperature information, and the preset temperature information includes the heat dissipation setting information corresponding to different application programs. In this way, the electronic apparatus may set the working state of the heat dissipation apparatus in correspondence with power consumption required by a name of the executed application program, so as to improve the performance of the electronic apparatus.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a temperature control method according to an embodiment of the invention.

FIG. 2 is a schematic view illustrating a portable electronic apparatus according to an embodiment of the invention.

FIG. 3 is a flowchart illustrating operations of a temperature control method according to another embodiment of the invention.

FIGS. 4A to 4C are schematic views respectively illustrating embodiments of user interfaces according to embodiments of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

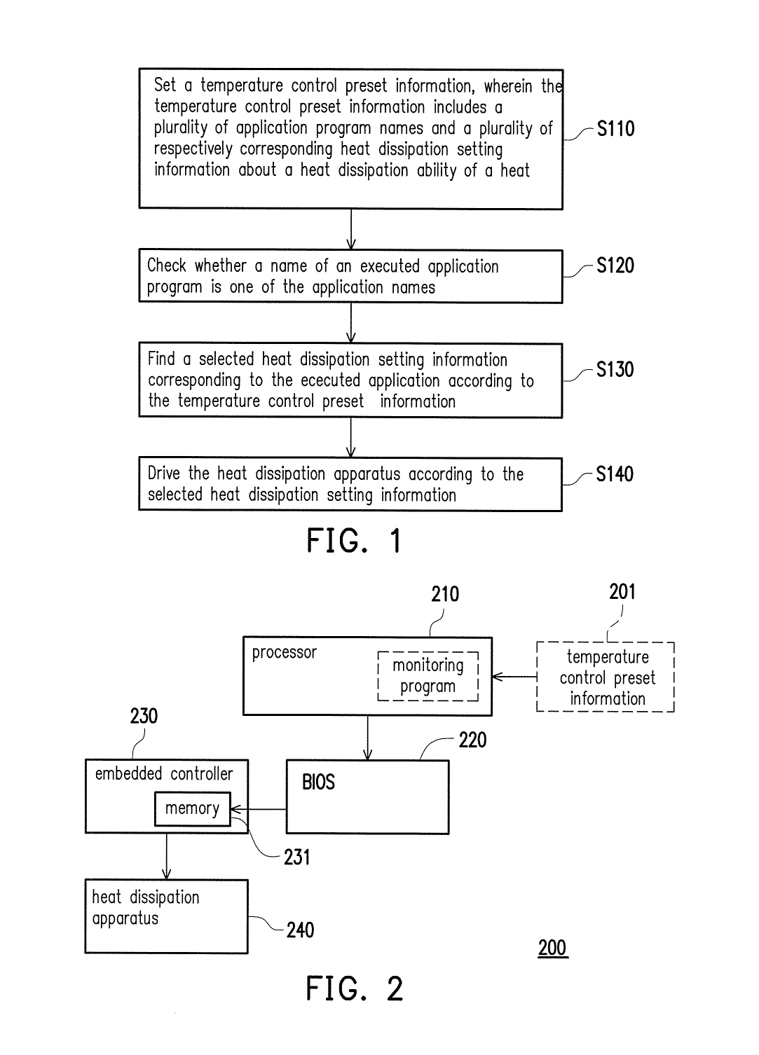

Referring to FIG. 1, FIG. 1 is a flowchart illustrating a temperature control method according to an embodiment of the invention. The temperature control method of this embodiment is suitable for an electronic apparatus, such as a desktop computer, a laptop computer, etc. At Step S110, a preset temperature information is set. The preset temperature information includes a plurality of application programs and a plurality of respectively corresponding heat dissipation setting information about a heat dissipation ability of a heat dissipation apparatus. Specifically, the heat dissipation apparatus may be a heat dissipation fan, and the heat dissipation setting information is a fan speed value of the heat dissipation fan.

It should be noted that the preset temperature information includes the application program names. Also, based on a scenario as required when the electronic apparatus executes each of the application programs, the preset temperature information also includes the heat dissipation setting information corresponding to the application program names. For example, if the preset temperature information includes a name of an application program which is a game application program, since the user may not need a very quiet environment when executing the game application program, the name of the game application program may correspond to a heat dissipation setting information having a higher fan speed. On the contrary, a name of a speech conversation application program may also be included in the preset temperature information, for example. Since the user may need a quieter environment when executing the speech conversation application program, the name of the speech conversation application program may correspond to a heat dissipation setting information having a lower fan speed. Please be noted here, the application program name may be not the official name of the application program, and the application program name recorded in the preset temperature information may be a code, a symbol or any other recognizable information

Then, at Step S120, whether an executed application program is one of the application programs included in the preset temperature information is checked. If a name of the executed application program is one of the application program names included in the preset temperature information, Step S130 is performed to select the heat dissipation setting information corresponding to the name of the executed application program included in the preset temperature information as a selected heat dissipation setting information. On the contrary, if the name of the executed application program is not one of the application program names included in the preset temperature information, the electronic apparatus may control the heat dissipation apparatus based on a preset heat dissipation setting information.

At Step S140, the electronic apparatus drives the heat dissipation apparatus according to the selected heat dissipation setting information.

An example is provided below to further describe the aforesaid steps. When the executed application program is a game application program, for example, through checking the preset temperature information, the heat dissipation setting information corresponding to the name of the executed application program in the preset temperature information may be selected as the selected heat dissipation setting information if the game application program is included in the preset temperature information. Also, the electronic apparatus may adjust the fan speed of the heat dissipation fan according to the selected heat dissipation setting information. Then, if the executed application program is switched to the speech conversation application program, through checking the preset temperature information, the heat dissipation setting information corresponding to the name of the speech conversation application program is selected as a new selected heat dissipation setting information. In this way, the electronic apparatus may adjust (slow down) the fan speed of the heat dissipation fan according to the new selected heat dissipation setting information, so as to reduce noises.

Based on the description, it can be known that the preset temperature information is used in this embodiment to dynamically adjust a working state of the heat dissipation apparatus according to a scenario requirement of the executed application program, so as to further improve a working efficiency of the electronic apparatus.

Referring to FIG. 2, FIG. 2 is a schematic view illustrating a portable electronic apparatus according to an embodiment of the invention. A portable electronic apparatus 200 includes a processor 210, a basic input output system (BIOS) 220, an embedded controller 230, and a heat dissipation apparatus 240. The processor 210 may be located with a preset temperature information 201 and execute a monitoring program 211. Through the monitoring program 211, the processor 210 checks whether the executed application program is included in the preset temperature information 201 and finds the heat dissipation setting information corresponding to the executed application program in the preset temperature information 201 as the selected heat dissipation setting information.

In addition, the processor 210 may transmit the selected heat dissipation setting information to the BIOS 220 to notify the BIOS 220 a currently required heat dissipation state. After receiving the notification, the BIOS 220 may transmit the selected heat dissipation setting information to the embedded controller 230 and write relevant information about the selected heat dissipation setting information to a memory 231 of the embedded controller 230.

In this way, the embedded controller 230 may adjust the heat dissipation ability of the heat dissipation apparatus 240 according to the relevant information about the selected heat dissipation setting information stored in the memory 231, such that the heat dissipation apparatus 240 may execute a heat dissipation operation corresponding to the executed application program.

It should also be noted that the preset temperature information 201 may be stored in advance in a memory apparatus readable for any processor 210. The memory apparatus includes a variety of types of memory, optical discs, soft disks, or hard disks, etc., in the portable electronic apparatus 200. Also, the memory 231 may be a memory built in the embedded controller 230, and there is no specific limitation on the form of the memory 231.

The preset temperature information 201 in the embodiments of the invention may be realized as a look-up table 1. An example of the look-up table 1 is provided below.

| | Temper- | Temper- | Temper- | Temper- | Temper- |
|---|---|---|---|---|---|
| | ature T0 | ature T1 | ature T2 | ature T3 | ature T4 |
| application | 0 | 2000 | 3000 | 3500 | 4000 |
| program 1 | | | | | |
| application | 0 | 2000 | 2800 | 3400 | 3800 |
| program 2 | | | | | |
| application | 0 | 2000 | 2500 | 2900 | 3500 |
| program 3 | | | | | |

In the look-up table 1, application programs 1 and 2 may be game application programs free of requirements on background noises of the environment, while an application program 3 is an application program that needs to be operated in a quieter scenario. Based on the look-up table 1, it can be known that in addition to different application programs corresponding to different temperatures T0 to T4, the look-up table 1 also provides different heat dissipation setting information. In other words, in the embodiments of the invention, the selected heat dissipation setting information may also be set based on a current temperature in addition to corresponding to the executed application program.

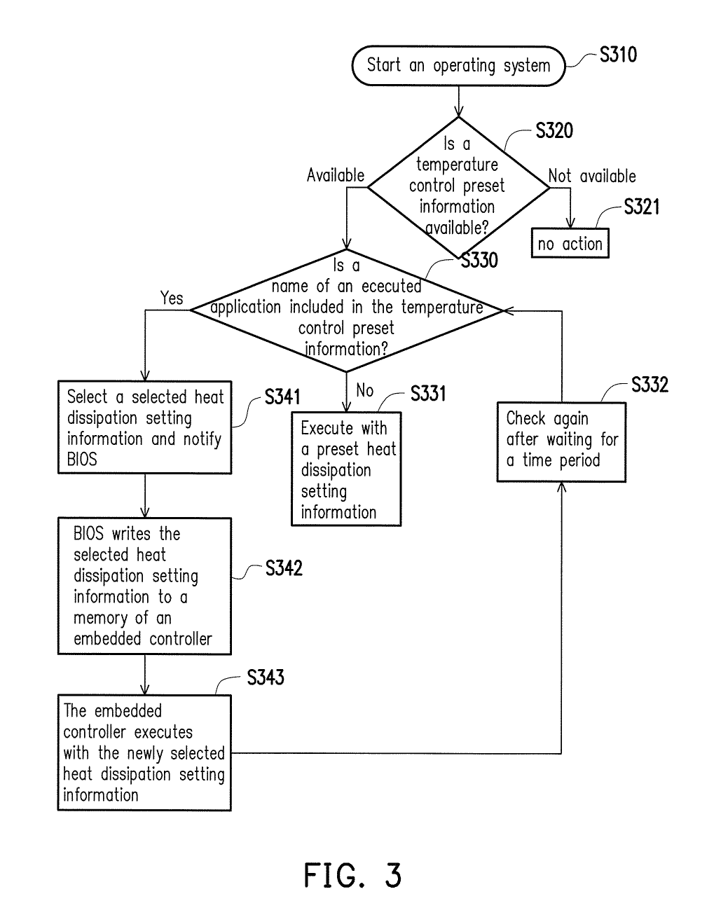

Referring to FIG. 3, FIG. 3 is a flowchart illustrating operations of a temperature control method according to another embodiment of the invention. In FIG. 3, an operating system is started at Step S310, and whether the preset temperature information is available in the portable electronic apparatus is checked at Step S320. When it is checked that the portable electronic apparatus does not have the preset temperature information, no operation concerning temperature control is executed (Step S321). On the contrary, when it is checked that the portable electronic apparatus has the preset temperature information, whether the executed application program is included in the preset temperature information is checked through the monitoring program at Step S330.

If an outcome of checking at Step S330 is “Yes”, Step S340 is performed to select the selected heat dissipation setting information corresponding to the executed application program and notify the basic input output system (BIOS) the selected heat dissipation setting information. At Step S342, the BIOS then writes the selected heat dissipation setting information to the memory of the embedded controller, and at Step S343, the embedded controller controls the heat dissipation apparatus according to the selected heat dissipation setting information stored in the memory of the embedded controller.

In addition, the monitoring program may periodically detect whether the executed application program is included in the preset temperature information. Thus, at Step S332, the monitoring program may check whether the executed application program is included in the preset temperature information again after waiting for a time period.

Also, when the outcome of checking at Step S330 is “No”, the portable electronic apparatus then drives the heat dissipation apparatus to execute a heat dissipation operation according to the preset heat dissipation setting information (Step S331), and checks again whether the executed application program is included in the preset temperature information after waiting for a time period.

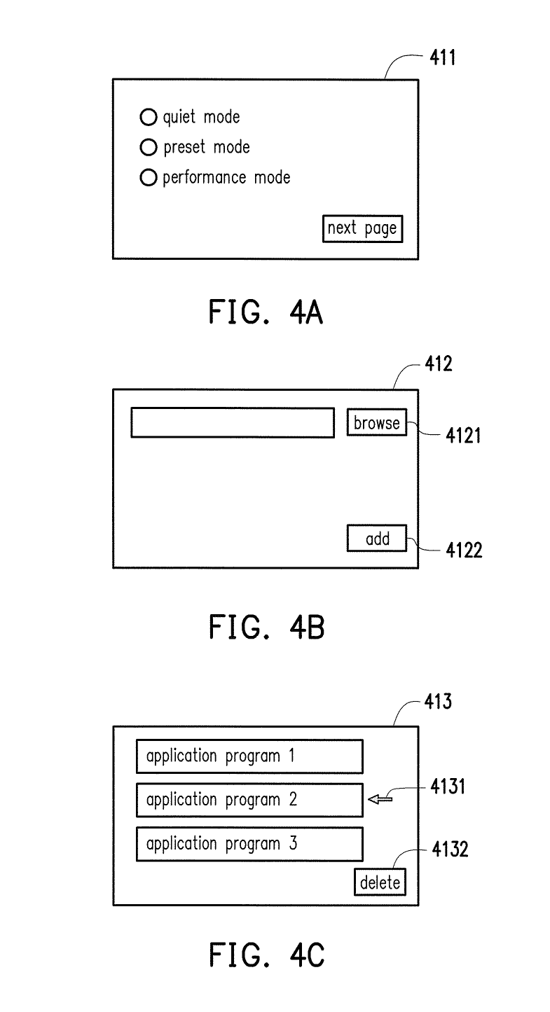

Referring to FIGS. 4A to 4C, FIGS. 4A to 4C are schematic views respectively illustrating embodiments of user interfaces according to embodiments of the invention. The user interface may be generated by the monitoring program and allow the user to edit the preset temperature information. In FIG. 4A, a user interface 411 allows the user to select between different modes. In addition, the user interface 411 provides a quiet mode, a preset mode, and a performance mode for the user's choice. The quiet mode indicates that the fan speed of the heat dissipation fan is unconditionally adjusted to a lower fan speed to keep the quietness of the environment. The preset mode indicates that the fan speed of the heat dissipation fan is adjusted according to the preset heat dissipation setting information. The performance mode indicates that the fan speed of the heat dissipation fan is adjusted according to the selected heat dissipation setting information found based on the executed application program together with the preset temperature information.

In FIG. 4B, a user interface 412 allows the user to add a new application program in the preset temperature information. In brief, the user only needs to browse all the application programs in the electronic apparatus by selecting a browse button 4121 in the user interface 412 and select an application program that the user wants to add to the preset temperature information, and then add the selected application program to the preset temperature information by using an add button 4122.

Besides, in FIG. 4C, a user interface 413 allows the user to remove an application program in the preset temperature information. The user may use a cursor 4131 on the user interface 413 to select one of the application programs 1, 2, and 3 in the preset temperature information and remove the application program in the reset temperature checking information by using a deletion button 4132.

It should be noted in particular that according to the embodiments of the invention, there may be more than one heat dissipation setting information corresponding to an application program in the preset temperature information. In the embodiments of the invention, the preset temperature information may include a plurality of heat dissipation setting information corresponding to different environmental temperatures for an application program. Under such circumstance, in addition to choosing a plurality of selected heat dissipation setting information based on the executed application program by using the monitoring program executed by the processor of the electronic apparatus, the electronic apparatus may further choose the suitable selected heat dissipation setting information from the plurality of selected heat dissipation setting information based on the current environmental temperature.

In view of the foregoing, the executed application program, together with the preset temperature information, are used in the invention to adjust the heat dissipation ability of the heat dissipation apparatus. In this way, the operation of the portable electronic apparatus may better fit the scenario required when the user operates the application program. Consequently, the performance of the portable electronic apparatus may be improved effectively.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A temperature control method, adapted for an electronic apparatus, comprising:
setting a preset temperature information, wherein the preset temperature information comprises a plurality of application program names and a plurality of heat dissipation setting information of a heat dissipation apparatus respectively corresponding to the application program names;
checking whether a name of an executed application program is one of the plurality of application program names;
if the name of the executed application program is one of the plurality of application program names, obtaining a selected heat dissipation setting information corresponding to the executed application program according to the preset temperature information; and
operating the heat dissipation apparatus according to the selected heat dissipation setting information.

2. The temperature control method as claimed in claim 1, wherein the step of obtaining the selected heat dissipation setting information corresponding to the executed application program according to the preset temperature information comprises:
executing a monitoring program to find the selected heat dissipation setting information corresponding to the executed application program in the preset temperature information; and
providing the selected heat dissipation setting information to a basic input output system through the monitoring program.

3. The temperature control method as claimed in claim 2, wherein the step of operating the heat dissipation apparatus according to the selected heat dissipation setting information comprises:
providing the basic input output system to write the selected heat dissipation setting information to a memory; and
providing an embedded controller to set a heat dissipation ability of the heat dissipation apparatus according to the selected heat dissipation setting information in the memory.

4. The temperature control method as claimed in claim 1, wherein the heat dissipation apparatus is a heat dissipation fan, and the selected heat dissipation setting information is configured to set a fan speed of the heat dissipation fan.

5. The temperature control method as claimed in claim 1, further comprising:
providing a user interface to allow a user to edit the preset temperature information.

6. The temperature control method as claimed in claim 1, wherein the step of obtaining the selected heat dissipation setting information corresponding to the executed application program according to the preset temperature information further comprises:
obtaining the selected heat dissipation setting information corresponding to the executed application program by using the preset temperature information according to a temperature.

7. An electronic apparatus, comprising:
a storage apparatus, configured to store a preset temperature information, wherein the preset temperature information comprises a plurality of heat dissipation setting information respectively corresponding to a plurality of application program names;
a processor, coupled to the storage apparatus, reading the preset temperature information, and when a name of an executed application program is one of the application program names, finding a selected heat dissipation setting information corresponding to the executed application program in the preset temperature information;
a basic input output system, coupled to the processor to receive the selected heat dissipation setting information;
an embedded controller, coupled to the basic input output system; and
a heat dissipation apparatus, coupled to the embedded controller,
wherein the basic input output system writes the selected heat dissipation setting information to the embedded controller, and the embedded controller operates the heat dissipation apparatus according to the selected heat dissipation setting information.

8. The electronic apparatus as claimed in claim 7, wherein the processor executes a monitoring program to find the selected heat dissipation setting information corresponding to the executed application program in the preset temperature information and provides the selected heat dissipation setting information to the basic input output system through the monitoring program.

9. The electronic apparatus as claimed in claim 7, wherein the embedded controller comprises:
a memory, configured to store the selected heat dissipation setting information,
wherein the embedded controller sets a heat dissipation ability of the heat dissipation apparatus according to the selected heat dissipation setting information in the memory.

10. The electronic apparatus as claimed in claim 7, wherein the heat dissipation apparatus is a heat dissipation fan, and the selected heat dissipation setting information is configured to set a fan speed of the heat dissipation fan.

11. The electronic apparatus as claimed in claim 7, wherein the processor further executes a user interface program to provide a user interface, and the user interface allows a user to edit the preset temperature information.

12. The electronic apparatus as claimed in claim 7, wherein the processor further finds the selected heat dissipation setting information corresponding to the executed application program in the preset temperature information according to an environmental temperature.
